(19) United States
(12) Patent Application Publication
(10) Pub. No.: US 2009/0131606 A1
(43) Pub. Date: May 21, 2009

(54) POLYURETHANE/POLYUREA ELASTOMERS BASED ON 2,4'-DIPHENYLMETHANE DIISOCYANATE PREPOLYMERS AND THE PRODUCTION THEREOF

(75) Inventors: Manfred Schmidt, Dormagen (DE); Jens Krause, Koeln (DE); Hartmut Nefzger, Pulheim (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/273,986

(22) Filed: Nov. 19, 2008

(30) Foreign Application Priority Data
Nov. 20, 2007 (DE) 102007055267.1
Aug. 30, 2008 (DE) 102008045223.8

(51) Int. Cl. C08L 75/02; C08L 75/06; C08L 75/08

(52) U.S. Cl. 525/460; 525/453

(57) ABSTRACT

The present invention relates to polyurethane/polyurea elastomers (PU elastomers) having improved processing characteristics, such as for example extended casting time and reduced brittleness, and occupational health and safety advantages, such elastomers being suitable for replacing elastomers based on TDI prepolymers in comparable applications, and to a process for their production and their use.

### RELATED APPLICATIONS

This application claims benefit to German Patent Application Nos. 10 2007 055 267, 1, filed Nov. 20, 2007, and 10 2008 045 223.8, filed Aug. 30, 2008, which are incorporated herein by reference in their entireties for all useful purposes.

### BACKGROUND OF THE INVENTION

The present invention relates to polyurethane/polyurea elastomers (PU elastomers) having improved processing characteristics, such as for example extended casting time and reduced brittleness, and occupational health and safety advantages, such elastomers being suitable for replacing elastomers based on TDI prepolymers in comparable applications, and to a process for their production and their use.

In order to produce PU elastomers, aromatic diisocyanates for example are reacted with long-chain polyols to form a prepolymer having terminal NCO groups. Such prepolymers can of course also contain free monomeric diisocyanates. Such prepolymers then undergo chain extension with a short-chain polyol or an aromatic polyamine to form a PU elastomer. Starting from the liquid NCO prepolymer and liquid chain extender, the viscosity of the reaction melt rises steadily until a solid elastomer has formed.

In industrial-scale production, liquids/melts which are storage-stable at room temperature are preferably used, since these are commonly able to be metered more effectively than solids. Carbodiimide/uretonimine (CD/UI) modifications of isocyanates therefore serve to lower the melting points of polyisocyanates. This problem of a high melting point occurs in particular with polyisocyanates of the diphenylmethane series (MDI), especially with monomeric 4,4′-diphenylmethane diisocyanate (4,4′-MDI), which melts at around 38° C. Owing to the fact that its melting point is low in comparison to MDI, this problem does not arise with TDI, for example.

There has been no shortage of attempts to lower the melting point of 4,4′-MDI by means of various modifications. Mention can be made here for example of allophanate modification (CA 2331469 A1) or conversion to semi-prepolymers (DE 1 618 380 A1), as well as carbodiimide modification (EP 0 515 933 A1).

As well as lowering the melting point, however, the loss of NCO groups should also be kept as low as possible and any rise in viscosity kept to a minimum.

For example, 4,4′-MDI (NCO content 33.5 wt. %) can be carbodiimide-modified (CD) or uretonimine-modified (UI) to an NCO content of 28.9 wt. %. After being stored for 7 days, this modified 4,4′-MDI gradually crystallises as a consequence adjust 15° C. If 4,4′-MDI is modified to an NCO content of 27.8 wt. %, crystallisation begins at as low as 5 to 10° C. However, the apparently obvious solution for lowering the melting point of improving the crystallisation tendency optionally by means of even further modification is not an option because of the fact that carbodiimide/uretonimine modification is associated with a rise in functionality (see scheme 1).

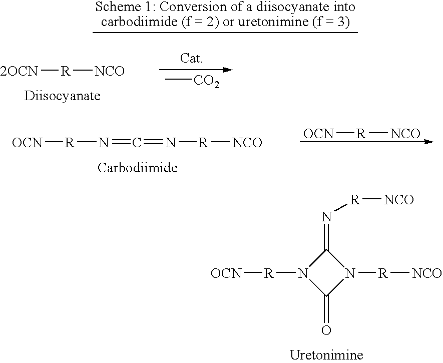

The rise in functionality has a very negative effect on the processing and material characteristics of the PU elastomers produced from these modified isocyanates. For example, the rise in molecular weight of the PU reaction mixture is greatly accelerated, i.e. the casting time reduces, and the mechanical properties, particularly tear propagation strength and long-term flexural strength, are very adversely affected.

The object was therefore to provide polyurethanes which can be produced from starting components that are liquid and storage-stable at room temperature, have good processing and material characteristics, wherein a broad range of polyurethane properties can be covered using as few as possible, readily accessible starting compounds.

This object was able to be achieved by using special isocyanate components to produce the polyurethane and aromatic amines as chain extenders.

### EMBODIMENTS OF THE INVENTION

An embodiment of the present invention is a polyurethane/polyurea elastomer obtainable by the reaction of components consisting of
A) an isocyanate component having an NCO content in the range of from 3 to 10 weight % consisting of
   A1) 5-20 wt. %, relative to A), of a carbodiim-nide(CD)-/uretonimine(UI)-modified 2,4′-diphenylmethane diisocyanate having an NCO content in the range of from 25 to 31.5 weight % and a crystallisation temperature below 20° C. obtained from diphenylmethane 10 diisocyanate containing in the range of from 90 to 100 weight % of 2,4′-diphenylmethane diisocyanate isomer;
   A2) 80-95 wt. %, relative to A), of an NCO prepolymer obtained from
      A2′) diphenylmethane diisocyanate containing 90 to 100 weight % of 2,4′-diphenylmethane diisocyanate isomer, and
      A2″) at least one polyol selected from the group consisting of polyether polyols and polyester polyols having a number-average molecular weight in the range of from 250 to 6000 g/mol and a functionality in the range of from 1.95 to 2.20;
   and
B) an aromatic diamine chain extender having a molecular weight of below 900 g/mol,
C) 0 to 2 wt. %, relative to the total amount of elastomer, of catalysts,
D) 0 to 0.5 wt. %, relative to the total amount of elastomer, of inhibitors,
E) 0 to 20 wt. %, relative to the total amount of elastomer, of flame retardant agents,
F) 0 to 10 wt. %, relative to the total amount of elastomer, of fillers,
G) 0 to 2 wt. %, relative to the total amount of elastomer, of antioxidants,
H) 0 to 5 wt. %, relative to the total amount of elastomer, of demolding agents,
I) 0 to 5 wt. %, relative to the total amount of elastomer, of coloring materials,
J) 0 to 10 wt. %, relative to the total amount of elastomer, of plasticizers,
K) 0 to 2 wt. %, relative to the total amount of elastomer, of biocides,
L) 0 to 3 wt. %, relative to the total amount of elastomer, of adhesion promoters,
M) 0 to 2 wt. %, relative to the total amount of elastomer, of antistatic agents and
N) 0 to 3 wt. %, relative to the total amount of elastomer, of blowing agents and/or water.

Yet another embodiment of the present invention is a process for producing the above polyurethane/polyurea elastomer, comprising mixing
A) an isocyanate component having an NCO content in the range of from 3 to 10 weight % consisting of
   A1) 5-20 wt. %, relative to A), of a carbodiimide (CD)-/uretonimine(UI)-modified 2,4′-diphenylmethane diisocyanate having an NCO content in the range of from 25 to 31.5 weight % and a crystallisation temperature below 20° C. obtained from diphenylmethane diisocyanate containing in the range of from 90 to 100 weight % of 2,4′-diphenylmethane diisocyanate isomer;
   A2) 80-95 wt. %, relative to A), of an NCO prepolymer obtained from
      A2′) diphenylmethane diisocyanate containing in the range of from 90 to 100 weight % of 2,4′-diphenylmethane diisocyanate isomer; and
      A2″) at least one polyol selected from the group consisting of polyether polyols and polyester polyols having a number-average molecular weight in the range of from 250 to 6000 g/mol and a functionality in the range of from 1.95 to 2.20;
with
B) an aromatic diamine chain extender having a molecular weight of below 900 g/mol,
C) 0 to 2 wt. %, relative to the total amount of elastomer, of catalysts,
D) 0 to 0.5 wt. %, relative to the total amount of elastomer, of inhibitors,
E) 0 to 20 wt. %, relative to the total amount of elastomer, of flame retardant agents,
F) 0 to 10 wt. %, relative to the total amount of elastomer, of fillers,
G) 0 to 2 wt. %, relative to the total amount of elastomer, of antioxidants,
H) 0 to 5 wt. %, relative to the total amount of elastomer, of demolding agents,
I) 0 to 5 wt. %, relative to the total amount of elastomer, of coloring materials,
J) 0 to 10 wt. %, relative to the total amount of elastomer, of plasticizers,
K) 0 to 2 wt. %, relative to the total amount of elastomner, of biocides,
L) 0 to 3 wt. %, relative to the total amount of elastomer, of adhesion promoters,
M) 0 to 2 wt. %, relative to the total amount of elastomer, of antistatic agents and
N) 0 to 3 wt. %, relative to the total amount of elastomer, of blowing agents and/or water
to form a mixture; and
reacting said mixture.

Yet another embodiment of the present invention is an electrical encapsulation comprising the above polyurethane elastomer.

Yet another embodiment of the present invention is a roller, wheel, doctor blade, hydrocyclone, screen, sports floor covering, or bumper comprising the above polyurethane elastomer.

### DESCRIPTION OF THE INVENTION

The invention therefore provides polyurethane/polyurea elastomers which are obtainable by the reaction of components consisting of
A) an isocyanate component having an NCO content of 3 to 10 wt. % consisting of
   A1) 5-20 wt. %, relative to A), of a carbodiimide-/uretonimine-modified 2,4′-diphenylmethane diisocyanate having an NCO content of 25 to 31.5 wt. % and a crystallisation temperature below 20° C. obtainable from diphenylmethane diisocyanate containing 90 to 100 wt. % of 2,4′-diphenylmethane diisocyanate isomer
   A2) 80-95 wt. %, relative to A), of an NCO prepolymer obtainable from
      A2′) diphenylmethane diisocyanate containing 90 to 100 wt. % of 2,4′-diphenylmethane diisocyanate isomer and
      A2″) at least one polyol from the group consisting of polyether polyols and polyester polyols having number-average molecular weights of 250 to 6000 g/mol and functionalities of 1.95 to 2.20
   and
B) aromatic diamine chain extenders having a molecular weight of below 900 g/mol,
C) 0 to 2 wt. %, relative to the total amount of elastomer, of catalysts,
D) 0 to 0.5 wt. %, relative to the total amount of elastomer, of inhibitors,
E) 0 to 20 wt. %, relative to the total amount of elastomer, of flame retardant agents,
F) 0 to 10 wt. %, relative to the total amount of elastomer, of fillers,
G) 0 to 2 wt. %, relative to the total amount of elastomer, of antioxidants,
H) 0 to 5 wt. %, relative to the total amount of elastomer, of demolding agents,
I) 0 to 5 wt. %, relative to the total amount of elastomer, of coloring materials,
J) 0 to I 0 wt. %, relative to the total amount of elastomer, of plasticizers,
K) 0 to 2 wt. %, relative to the total amount of elastomer, of biocides,
L) 0 to 3 wt. %, relative to the total amount of elastomer, of adhesion promoters,
M) 0 to 2 wt. %, relative to the total amount of elastomer, of antistatic agents and
N) 0 to 3 wt. %, relative to the total amount of elastomer, of blowing agents and/or water.

The use of 2,4′-MDI both in the production of the NCO prepolymer and as the basis of component A1) eliminates the aforementioned disadvantages and results in
1. an improved toxicology in comparison to TDI prepolymers
2. an improved reactivity in comparison to 4,4′-MDI prepolymers
3. an improved low-temperature stability of the CD-/UI-modified 2,4′-MDI used, wherein
4. PU elastomers having an improved level of properties in comparison to TDI systems are obtained,
5. the CD-/UI-modified 2,4′-MDI can be metered in liquid form, such that the NCO content of the prepolymers can easily be increased without having to turn to solid MDI derivatives or solid 2,4′-MDI or without having to use modifications containing 4,4′-MDI, which would increase the reactivity too greatly.

The invention also provides a process for producing the polyurethane/polyurea elastomers according to the invention, wherein
A) an isocyanate component having an NCO content of 3 to 10 wt. % consisting of
   A1) 5-20 wt. %, relative to A), of a carbodiimide-/uretonimine-modified 2,4′-diphenylmethane diisocyanate having an NCO content of 25 to 31.5 wt. % and a crystallisation temperature below 20° C. obtainable from diphenylmethane diisocyanate containing 90 to 100 wt. % of 2,4′-diphenylmethane diisocyanate isomer
   A2) 80-95 wt. %, relative to A), of an NCO prepolymer obtainable from
      A2′) diphenylmethane diisocyanate containing 90 to 100 wt. % of 2,4′-diphenylmethane diisocyanate isomer and
      A2″) at least one polyol from the group consisting of polyether polyols and polyester polyols having number-average molecular weights of 250 to 6000 g/mol and functionalities of 1.95 to 2.20
         is mixed with
B) an aromatic diamine chain extender having a molecular weight of below 900 g/mol,
C) 0 to 2 wt. %, relative to the total amount of elastomer, of catalysts,
D) 0 to 0.5 wt. %, relative to the total amount of elastomer, of inhibitors,
E) 0 to 20 wt. %, relative to the total amount of elastomer, of flame retardant agents,
F) 0 to 10 wt. %, relative to the total amount of elastomer, of fillers,
G) 0 to 2 wt. %, relative to the total amount of elastomer, of antioxidants,
U) 0 to 5 wt. %, relative to the total amount of elastomer, of demolding agents,
J) 0 to 5 wt. %, relative to the total amount of elastomer, of coloring materials,
J) 0 to 10 wt. %, relative to the total amount of elastomer, of plasticizers,
K) 0 to 2 wt. %, relative to the total amount of elastomer, of biocides,
L) 0 to 3 wt. %, relative to the total amount of elastomer, of adhesion promoters,
M) 0 to 2 wt. %, relative to the total amount of elastomer, of antistatic agents and
N) 0 to 3 wt. %, relative to the total amount of elastomer, of blowing agents and/or water
   and caused to react.

CD-/UI-modified 2,4′-MDI is obtained by reacting MDI having a 2,4′-isomer content of 90 to 100 wt. %, preferably 95 to 100 wt. %, particularly preferably 98 to 100 wt. %, preferably with the use of catalysts, for example phospholine derivatives. Phospholine-type catalysts are described for example in EP-A 515 933 and U.S. Pat. No. 6,120,699. Typical examples of these catalysts are the mixtures of phospholine oxides known from the prior art

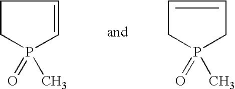

The amount of catalyst used depends on the quality and/or reactivity of the starting isocyanate. The simplest option is therefore to determine the amount of catalyst required in each case in a preliminary test.

The carbodiimide/uretonimine modification reaction is conventionally performed in a temperature range from 50 to 150° C., preferably 60 to 100° C. Markedly higher reaction temperatures (up to approx. 280° C.) are also possible, however. The optimum reaction temperature is governed by the type of catalyst used and can likewise by determined in a preliminary test.

In a typical batch 2,4′-MDI is caused to react with 2 to 3 ppm of phospholine oxide at 80 to 100° C. in approximately 5 to 6 hours.

The carbodiimide/uretonimine modification reaction is terminated when an NCO content of 25 to 31.5 wt. %, preferably 27 to 30.5 wt. %, particularly preferably 28 to 30 wt. %, is achieved, by adding a stopper.

The NCO content is determined in the manner known to the person skilled in the art, either by titration or by an online method (e.g. near-infrared analysis). The progress of the reaction can of course also be determined from the amount of carbon dioxide escaping. This carbon dioxide amount, which can be determined by volumetric means, gives an indication of the degree of conversion achieved at a given time.

To terminate the reaction, at least the equimolar amount of a stopper is used, particularly preferably a 1 to 20 times molar excess, most particularly preferably a 1 to 10 times molar excess.

Such stoppers are mentioned for example in DE-A 25 37 685, EP-A 515 933, EP-A 609 698 and U.S. Pat. No. 6,120,699 and include for example acids, acid chlorides, chloroformates, silylated acids and alkylating agents, such as for example esters of trifluoromethanesulfonic acid, such as ethyl trifluoromethanesulfonic acid (ETF), for example. Silylated acids are trimethylsilyltrifluoromethanesulfonate (TMST), for example.

The stopper can be added to the reaction mixture in either one or two portions, the second portion being added after cooling, for example to room temperature.

After the reaction has been terminated the reaction mixture can of course be completely freed from the carbon dioxide formed by application of a vacuum.

This CD-/UI-modified 2,4′-MDI has the advantage over the correspondingly modified 4,4′-MDI that with the same NCO content, i.e. the same degree of carbodiimide modification, it crystallises at lower temperatures. This is an important processing advantage, of course, since this product does not have to be stored at an elevated temperature. This advantageous property can also be seen from Table 1.

The NCO prepolymers A2) are obtained by reacting a high-molecular-weight polyol with 2,4′-MDI. High-molecular-weight polyols are in particular hydroxyl group-terminated polyether and polyester polyols having a number-average molecular weight of 250 to 6000 g/mol, preferably 500 to 4000 g/mol.

Polyether polyols can be described by the general formula HO(RO)ₙH, wherein R is an alkylene radical and n assumes values such that the molecular weight is in the range from 250 to 6000 g/mol. These polyether polyols are polyols known to the person skilled in the art which are obtained by ring-opening polymerisation of monomeric cyclic ethers or by acid-catalyzed condensation of diols or dihydroxyethers. Polyether polyols are normally bifunctional, but by choosing suitable higher-functional starters they can also have higher functionalities. Typical monomeric cyclic ethers are ethylene oxide, propylene oxide and tetrahydrofuran.

Polyester polyols are obtained by reacting dicarboxylic acids with diols, with separation of water. Important dicarboxylic acids are adipic, glutaric, succinic, sebacic or phthalic acid, this last mostly being used in the form of the anhydride. Important diols are ethylene, 1,2-propylene, 1,3-propylene, 1,4-butylene or diethylene glycol, but also 1,6-hexanediol and the isomers thereof. In addition, to set a functionality higher than 2, structural units from the group comprising glycerol, 1,1,1-trimethylolpropane, pentaerythritol and sorbitol can be used.

Furthermore, ε-caprolactone and dimerised fatly acids can also be used to produce polyester polyols. Polycarbonate polyols can also be used, of course.

The 2,4′-MDI-based prepolymers are produced for example by allowing the polyol in question to run slowly into the prepared melted 2,4′-MDI. The reaction is then completed by stirring for a further 2 to 8 hours at elevated temperature, preferably 40 to 100° C., particularly preferably 50 to 90° C.

The prepolymers are blended with the CD-/UI-modified 2,4′-MDI before use in order to vary the NCO content of the prepolymer.

The blends of 2,4′-MDI prepolymer and CD-/UI-modified 2,4′-MDI are then reacted with chain extenders. Cast elastomers are obtained which correspond in their properties to those produced with the added use of CD-/UI-modified 4,4′-MDI, although in this case the disadvantage of increased reactivity, i.e. a shorter casting time, occurs.

The advantage is that processing can take place with two isocyanate raw materials which are liquid at ambient temperature and cast elastomers having a broad range of properties can be produced which would otherwise only be attainable with a large number of raw materials.

In order to cover a broad range of properties, particularly with regard to the hardness of the PU elastomers, with where possible just one NCO prepolymer, the NCO prepolymer is supplemented with monomeric diisocyanate. These monomeric diisocyanates should advantageously likewise be able to be stored and used in liquid form at ambient temperature, however. The CD-/UI-modified 2,4′-MDI that is used satisfies these requirements.

As component B) aromatic diamines are exclusively used. The molecular weight of component B) is below 900 g/mol. Jeffamines® available on the market are not used as component B). Other oligomeric or polymeric aliphatic diamines are also not used as component B).

The chain extenders for producing the cast elastomers are the aromatic diamines known per se. Aromatic diamines which have a low melting point or are liquid are preferred. Diamines which melt below 120° C. are particularly preferred.

Aromatic amine chain extenders are, for example, 4,4′-methylene bis-(2-chloroaniline) (MBOCA), 3,3′,5,5′-tetraisopropyl-4,4′-diaminodiphenylmethane, 3,5-dimethyl-3′,5′-diisopropyl-4,4′-diaminophenylmethane, 3,5-diethyl-2,4-toluylene diamine, 3,5-diethyl-2,6-toluylene diamine (DETDA), 4,4′-methylene bis-(3-chloro-2,6-diethylaniline), 3,5-dimethylthio-2,4-toluylene diamine, 3,5-dimethylthio-2,6-toluylene diamine (Ethacure™ 300, Albemarle Corporation), methylene dianiline, trimethylene glycol-di-p-amino-benzoate (Polacure™ 740, Air Products and Chemicals Inc.), 1,2-bis-(2-aminophenylthio)ethane (Cyanacure™, American Cyanamid Company), t-but.-toluene diamine (TBTDA), 3,5-diamino-4-chlorobenzoic acid isobutyl ester (Baytec® XL 1604, Bayer MaterialScience AG) or 4,4′-methylene bis-(3-chloro-2,6-diethylaniline (Lonzacure™, MCDEA).

Components C) to N) are well-known additives and auxiliary agents which are described in G. Oertel, Polyurethane Handbook, 2^{nd} edition, C. Hanser Verlag 1993, pages 98 ff.

Common catalysts can also be used if required in the production of the elastomers.

As examples for auxiliary substances and additives, acid stabilisers, for example chloropropionic acid, dialkyl phosphates, p-toluenesulfonic acid, or acid chlorides, such as benzoic acid chloride, phthalic acid dichloride, and antioxidants, such as for example Ionol®, phosphites and Stabaxol® as hydrolysis stabilisers can be named. Fillers, for example carbon black, carbon nanotubes, chalk and glass fibers as well as coloring agents can be used.

The cast elastomers are preferably produced by first degassing the isocyanate component at elevated temperature and under reduced pressure whilst stirring, and then stirring it with the chain extender and pouring the reacting melt into preheated moulds.

The cast elastomers are used in applications requiring good mechanical properties, for example as industrial rolls in the paper industry, for example, and as rollers and wheels, doctor blades, hydrocyclones, screens, sports floor coverings and bumpers as well as for electrical encapsulation.

The invention is illustrated in more detail by the examples below.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

Chemicals used

| | |
|---|---|
| 4,4′-MDI: | Desmodur ® 44M from Bayer MaterialScience AG |
| | (4,4′-diphenylmethane diisocyanate) |
| 2,4′-MDI: | 2,4′-Diphenylmethane diisocyanate |
| Desmodur ® CD-S: | Carbodiimide-/uretonimine-modified Desmodur ® |
| | 44M (isocyanate based on 4,4′-MDI) having an NCO |
| | content of 29.5 wt. % from Bayer MaterialScience AG |
| | with a crystallisation range from 15 to 20° C. |
| Phospholine oxide-type catalyst: | Technical mixture of 1-methyl-1-oxo-1-phospha- |
| | cyclopent-2-ene and 1-methyl-1-oxo-1- |
| | phosphacyclopent-3-ene, 1 wt. % in toluene. |
| Stopper: | Trifluoromethanesulfonic acid ethyl ester (stopper A) |
| | or trimethylsilyltrifluoromethanesulfonate (stopper B) |
| Desmodur ® VP.PU ME 40TF04: | Ether-based NCO prepolymer made from 2,4′-MDI |
| | with an NCO content of 3.9 wt. % from Bayer |
| | MaterialScience AG |
| Desmodur ® VP.PU ME 80TF04: | Ether-based NCO prepolymer made from 2,4′-MDI |
| | with an NCO content of approx. 8 wt. % from Bayer |
| | MaterialScience AG |
| Desmodur ® VP.PU ME 60TF04: | Ether-based NCO prepolymer made from 2,4′-MDI |
| | with an NCO content of approx. 6 wt. % from Bayer |
| | MaterialScience AG |
| Baytec ® XL 1604: | 3,5-Diamino-4-chlorobenzoic acid isobutyl ester from |
| | Bayer MaterialScience AG |

### Production of MDI Containing Carbodiimide/Uretonimine Groups

10 kg of the isocyanate concerned were heated under nitrogen to 90° C. whilst stirring. 2.5 ppm of the catalyst in the form of a 1% solution in toluene were then added. The reaction mixture was heated under nitrogen at 90° C. whilst stirring until the desired NCO content was reached. The progress of the reaction was monitored via the gas evolution. After the end of the reaction the carbodiimidisation was terminated by the addition of 10 to 50 ppm of stopper. Stirring was continued for one hour.

The results are summarised in Table 1 below:

TABLE 1
Production of MDI containing carbodiimide/uretonimine groups

| | | Example | | | |
|---|---|---|---|---|---|
| | | A-1 | A-2 | A-3 | A-4 (C) |
| Isocyanate | | 2,4′-MDI | 2,4′-MDI | 2,4′- | 4,4′- |
| Stopper type | | A | A | A | B |
| Amount of stopper | [ppm] | 50 | 10 | 50 | 50 |
| NCO content | [wt. % | 29.1 | 29.5 | 28.2 | 27.8 |
| | NCO] | | | | |
| Viscosity | [mPas, | 38 | 42 | 75 | 77 |
| | 25° C.] | | | | |
| Crystallisation range | [° C.] | <−10 | <−10 | <−10 | >0 |
| after storage for 30 | | | | | |
| days | | | | | |

(C)—Comparison

Table 1 (Examples A-1 and A-2) shows that carbodiimide/uretonimine group-containing 2,4′-MDI with stopper amounts of 50 and 10 ppm and an NCO content of 29.1 to 29.5% delivers practically identical products in terms of crystallisation range and viscosity. Examples A-3 and A-4 show that with almost identical NCO contents the product according to the invention has the more favourable, i.e. lower, crystallisation range.

Example A-4 (C) shows that even with a high degree of modification, i.e. a low NCO value, good crystallisation properties are not achieved with 4,4′-MDI.

### Production of Blends of NCO Prepolymers and Carbodiimide-/Uretonimine-Modified MDI

The carbodiimide-/uretonimine-modified 2,4′-MDI according to example A-1 was homogenised with Desmodur® VP.PU ME 40TF04 for one hour under nitrogen at 80° C. The NCO content and viscosity were then determined.

Further data and the amounts used are set out in Table 2.

TABLE 2
Production of blends of Desmodur ® VP.PU ME40TF04 and various
carbodiimide-/uretonimine-modified MDI grades

| | Example | | | | |
|---|---|---|---|---|---|
| | B-1 (C) | B-2 (C) | B-3 | B-4 | B-5 |
| Prepolymer | 91.97 | 84.18 | 91.97 | 84.18 | 91.97 |
| [wt. %] Desmodur ® | | | | | |
| VP.PU ME40TF04 | | | | | |
| Isocyanate as per | | | 8.03 | 15.82 | |
| Ex. A-1 [wt. %] | | | | | |
| Isocyanate as per | | | | | 8.03 |
| Ex. A-2 [wt. %] | | | | | |
| Desmodur ® 44 CD-S | 8.03 | 15.82 | | | |
| [wt. %] | | | | | |
| NCO content | 6 | 8.02 | 5.97 | 7.99 | 5.96 |
| [wt. %] | | | | | |
| Viscosity at 70° C. | 1678 | 1188 | 1747 | 1249 | 1780 |
| [mPas] | | | | | |

Production of Cast Elastomers from the Blends in Table 2

The cast elastomers were produced using Baytec® XL 1604 (3,5-diamino-4-chlorobenzoic acid isobutyl ester) as crosslinker, the blends being stirred with Baytec® XL 1604 preheated to 100° C. for 30 seconds with degassing at 90° C. The reacting melt was poured into moulds preheated to 110° C. and cured for 24 hours at 110° C. The mouldings were then stored for 7 days at room temperature and the mechanical values determined (see Table 3).

TABLE 3
Production and properties of cast elastomers

| | | Example | | | | | | |
|---|---|---|---|---|---|---|---|---|
| | | C-1 (C) | C-2 (C) | C-3 | C-4 | C-5 | C-6 (C) | C-7 (C) |
| | | B-1 (C) | B-2 (C) | B-3 | B-4 | B-5 | B-6 (C) | B-7 (C) |
| Blend of Desmodur ® | 4,4′-CDS | X | X | | | | | |
| VP.PU ME 40TF04 | 2,4′-CDS | | | X | X | X | | |
| and | | | | | | | | |
| Prepolymer | | | | | | | X *1) | X *2) |
| Amount of blend or | [parts] | 100 | 100 | 100 | 100 | 100 | 100 | 100 |
| prepolymer | | | | | | | | |
| Amount of Baytec ® | [parts] | 15.2 | 20.3 | 15.1 | 20.2 | 15.2 | 20.3 | 15.2 |
| XL1604 | | | | | | | | |
| Casting time | [sec] | 115 | 50 | 170 | 85 | 210 | 150 | 270 |
| Mechanical | | | | | | | | |
| properties | | | | | | | | |
| Shore A | | 100 | 101 | 99 | 101 | 99 | 99 | 97 |
| (DIN 53505) | | | | | | | | |
| Shore D | | 47 | 60 | 45 | 59 | 46 | 54 | 45 |
| (DIN 53505) | | | | | | | | |
| Modulus (100%) | [MPa] | 12.5 | 19.3 | 12.0 | 17.4 | 11.8 | 17.4 | 12.4 |
| (DIN 53504) | | | | | | | | |
| Modulus (300%) | [MPa] | 22.9 | 39.7 | 22.2 | 31.6 | 20.0 | 28.2 | 19.5 |
| (DIN 53504) | | | | | | | | |
| Yield stress | [MPa] | 42.3 | 39.7 | 39.4 | 41.2 | 38.6 | 38.2 | 40.0 |
| (DIN 53504) | | | | | | | | |
| Ultimate elongation | [%] | 414 | 300 | 415 | 375 | 420 | 395 | 481 |
| (DIN 53504) | | | | | | | | |
| Graves | [kN/m] | 68 | n.d. | 61 | 100 | 74 | 119 | 89 |
| (DIN 53515) | | | | | | | | |
| Impact resilience | [%] | 48 | 53 | 47 | 51 | 47 | 49 | 46 |
| (DIN 53512) | | | | | | | | |
| Abrasion | [mm³] | 47 | 34 | 53 | 46 | 45 | 56 | 49 |
| (DIN 53516) | | | | | | | | |
| Compression set, | [%] | 35.1 | 42.3 | 25.1 | 36.1 | 26.3 | 37.8 | 30.0 |
| 22° C. | | | | | | | | |
| (DIN 53517) | | | | | | | | |
| Compression set, | [%] | 62.3 | 75.1 | 52.2 | 66.6 | 48.7 | 63.4 | 60.9 |
| 70° C. | | | | | | | | |
| (DIN 53517) | | | | | | | | |
| | | | brittle | | | | | |

*1): Desmodur ® VP.PU ME 80TF04: Ether-based NCO prepolymer made from 2,4′-MDI with an NCO content of approx. 8 wt. % from Bayer MaterialScience AG
*2): Desmodur ® VP.PU ME 60TF04: Ether-based NCO prepolymer made from 2,4′-MDI with an NCO content of approx. 6 wt. % from Bayer MaterialScience AG
4,4′-CDS: Carbodiimide-/uretonimine-modified 4,4′-MDI
2,4′-CDS: Carbodiimide-/uretonimine-modified 2,4′-MDI
(C): Comparative test

Table 3 shows that when prepolymers/blends with the same NCO content i.e. the same amounts of added Baytec® XL1604, are used, the casting time is reduced disadvantageously if carbodiimide-/uretonimine-modified 4,4′-MDI is used as the blend component. Thus the cast elastomers according to the invention C-3 and C-5 have a casting time of 170 seconds and 210 seconds respectively, whereas the comparative example C-1 (C) has a casting time of just 115 seconds. The two systems according to the invention (C-3 and C-5) even achieve almost the same casting time as the elastomer produced directly C-7 (C) and can be readily processed without difficulty.

In this way elastomers (C-3 and C-5) are obtained from blends of low-NCO-containing prepolymers with modified 2,4′-MDI which have the same level of properties as elastomers produced directly with 2,4′-MDI prepolymers (C-7 (C)). This means that by blending a high-NCO-containing isocyanate component and a low-NCO-containing prepolymer, elastomers can be produced having properties which are normally obtained only by using special isocyanate components.

Similar observations can also be made for the systems produced with around 20 parts by weight of Baytec® XL1604. Naturally these systems are generally somewhat faster owing to the higher NCO content in the prepolymer.

Within allowable margins for error, the mechanical properties listed in Table 3 are similar for elastomers made from prepolymers with the same NCO contents, the use of elevated amounts of Desmodur® CD-S (4,4′-CDS) to achieve higher NCO contents (Example C-2 (C)) leading disadvantageously to brittle products.

Taken as a whole, the elastomers according to the invention C-3, C-4 and C-5 therefore represent optimal solutions.

1. A polyurethane/polyurea elastomer obtainable by the reaction of components consisting of
A) an isocyanate component having an NCO content in the range of from 3 to 10 weight % consisting of
A1) 5-20 wt. %, relative to A), of a carbodiimide-/uretonimine-modified 2,4′-diphenylmethane diisocyanate having an NCO content in the range of from 25 to 31.5 weight % and a crystallisation temperature below 20° C. obtained from diphenylmethane diisocyanate containing in the range of from 90 to 100 weight % of 2,4′-diphenylmethane diisocyanate isomer;
A2) 80-95 wt. %, relative to A), of an NCO prepolymer obtained from
A2′) diphenylmethane diisocyanate containing 90 to 100 weight % of 2,4′-diphenylmethane diisocyanate isomer, and
A2″) at least one polyol selected from the group consisting of polyether polyols and polyester polyols having a number-average molecular weight in the range of from 250 to 6000 g/mol and a functionality in the range of from 1.95 to 2.20;
and
B) an aromatic diamine chain extender having a molecular weight of below 900 g/mol,
C) 0 to 2 wt. %, relative to the total amount of elastomer, of catalysts,
D) 0 to 0.5 wt. %, relative to the total amount of elastomer, of inhibitors,
E) 0 to 20 wt. %, relative to the total amount of elastomer, of flame retardant agents,
F) 0 to 10 wt. %, relative to the total amount of elastomer, of fillers,
G) 0 to 2 wt. %, relative to the total amount of elastomer, of antioxidants,
H) 0 to 5 wt. %, relative to the total amount of elastomer, of demolding agents,
I) 0 to 5 wt. %, relative to the total amount of elastomer, of coloring materials,
J) 0 to 10 wt. %, relative to the total amount of elastomer, of plasticizers,
K) 0 to 2 wt. %, relative to the total amount of elastomer, of biocides,
L) 0 to 3 wt. %, relative to the total amount of elastomer, of adhesion promoters,
M) 0 to 2 wt. %, relative to the total amount of elastomer, of antistatic agents and
N) 0 to 3 wt. %, relative to the total amount of elastomer, of blowing agents and/or water.

2. A process for producing the polyurethane/polyurea elastomer of claim 1, comprising mixing
A) an isocyanate component having an NCO content in the range of from 3 to 10 weight % consisting of
A1) 5-20 wt. %, relative to A), of a carbodiimide-/uretonimine-modified 2,4′-diphenylmethane diisocyanate having an NCO content in the range of from 25 to 31.5 weight % and a crystallisation temperature below 20° C. obtained from diphenylmethane diisocyanate containing in the range of from 90 to 100 weight % of 2,4′-diphenylmethane diisocyanate isomer;
A2) 80-95 wt. %, relative to A), of an NCO prepolymer obtained from
A2′) diphenylmethane diisocyanate containing in the range of from 90 to 100 weight % of 2,4′-diphenylmethane diisocyanate isomer; and
A2″) at least one polyol selected from the group consisting of polyether polyols and polyester polyols having a number-average molecular weight in the range of from 250 to 6000 g/mol and a functionality in the range of from 1.95 to 2.20;
with
B) an aromatic diamine chain extender having a molecular weight of below 900 g/mol,
C) 0 to 2 wt. %, relative to the total amount of elastomer, of catalysts,
D)) 0 to 0.5 wt. %, relative to the total amount of elastomer, of inhibitors,
E) 0 to 20 wt. %, relative to the total amount of elastomer, of flame retardant agents,
F) 0 to 10 wt. %, relative to the total amount of elastomer, of fillers,
G) 0 to 2 wt. %, relative to the total amount of elastomer, of antioxidants,
H) 0 to 5 wt. %, relative to the total amount of elastomer, of demolding agents,
I) 0 to 5 wt. %, relative to the total amount of elastomer, of coloring materials,
J) 0 to 10 wt. %, relative to the total amount of elastomer, of plasticizers,
K) 0 to 2 wt. %, relative to the total amount of elastomer, of biocides,
L) 0 to 3 wt. %, relative to the total amount of elastomer, of adhesion promoters,
M) 0 to 2 wt. %, relative to the total amount of elastomer, of antistatic agents and
N) 0 to 3 wt. %, relative to the total amount of elastomer, of blowing agents and/or water
to form a mixture; and
reacting said mixture.

3. An electrical encapsulation comprising the polyurethane elastomer of claim 1.

4. A roller, wheel, doctor blade, hydrocyclone, screen, sports floor covering, or bumper comprising the polyurethane elastomer of claim 1.
